(19) United States
(12) Patent Application Publication
(10) Pub. No.: US 2015/0195387 A1
(43) Pub. Date: Jul. 9, 2015

(54) METHODS AND SYSTEMS FOR FLEXIBLE PACKET CLASSIFICATION

(71) Applicant: Cavium, Inc., San Jose, CA (US)

(72) Inventor: Wilson Parkhurst Snyder, II, Holliston, MA (US)

(73) Assignee: CAVIUM, INC., San Jose, CA (US)

(21) Appl. No.: 14/150,657

(22) Filed: Jan. 8, 2014

(51) Int. Cl. H04L 29/06; H04L 12/743; H04L 29/08

(52) U.S. Cl. CPC H04L 69/22; H04L 67/10; H04L 45/7457

(57) ABSTRACT

A network packet classification method comprises receiving parse information derived from parsing a field in a network packet; comparing the parse information with information in a table to derive a comparison result, wherein the table includes information for mapping the field with one or more comparison results; based on the comparison result deriving a style value for the network packet; classifying the packet based on the style value; and processing the packet based on the classification. According to some embodiments, the method further comprises deriving or receiving an initial style value for the network packet, wherein deriving the style value includes modifying the initial style value based on the comparison result. According to some embodiments, the initial style value depends on a network path through which the network packet is received. The network path may include an interface or a channel through which the network packet is received.

### RELATED APPLICATION(S)

This application is related to the concurrently filed U.S. patent applications titled “Methods and Systems for Single Instruction Multiple Data Programmable Packet Parsers,” Attorney Docket No. CVM-010US; and “Floating Mask Generation for Network Packet Flow,” Attorney Docket No. CVM-012US. The entire contents of both applications are incorporated herein by reference.

### TECHNICAL FIELD

The present disclosure relates generally to computer networks and in particular to methods and systems for flexible classification of network packets.

### BACKGROUND

Many electronic devices, such as computers, communicate via network packets. The network packets are usually sent from a source to a destination. During this journey the packet may pass through one or more intermediary recipients before reaching the final recipient, i.e., the destination. Different types of recipients include network processors, network switches, and network interfaces. Each recipient of the packet may need to parse the packet, that is, analyze the data in the packet to determine its characteristics. The characteristics of a network packet may include its source, destination, or type. The recipients utilize parsing mechanisms to perform the parsing. As part of the parsing, the recipient may split the bytes in the packet into its different network protocol layers and fields within those protocols, to enable further processing.

The number and complexity of network protocols are constantly growing. Previous parsing techniques lack the required flexibility and speed to handle this growth. To handle a new or an updated networking protocol, for example, these techniques may require updating their networking hardware or software. Otherwise, the systems may not be able to service the new or updated protocol or may service it at a lower than desirable speeds.

### SUMMARY

Some embodiments provide a network packet classification method comprising receiving parse information derived from parsing a field in a network packet; comparing the parse information with information in a table to derive a comparison result, wherein the table includes information for mapping the field with one or more comparison results; based on the comparison result deriving a style value for the network packet; classifying the packet based on the style value; and processing the packet based on the classification.

According to some embodiments, the method further comprises deriving or receiving an initial style value for the network packet, wherein deriving the style value includes modifying the initial style value based on the comparison result. According to some embodiments, the initial style value depends on a network path through which the network packet is received. According to some embodiments, the initial style value includes a parse mode determining how to parse the network packet. According to some embodiments, the network packet includes a plurality of fields and wherein the parse mode determines that one or more of the plurality of fields should be parsed. According to some embodiments, deriving the style value includes modifying the parse mode. According to some embodiments, the network path includes an interface or a channel through which the network packet is received.

According to some embodiments, the table is stored in a content addressable memory. According to some embodiments, the field is a first field, the parse information is a first parse information, the table is one table of one or more tables, the comparison result is a first comparison result, and the style value is a first style value, the method further comprising: receiving second parse information derived from parsing a second field in the network packet; comparing the second parse information with information in the one or more tables to derive a second comparison result; based on the second comparison result modifying the first style value to derive a second style value for the network packet; and classifying the packet based on the second style value. According to some embodiments, modifying the first style value includes, based on the second comparison results, performing an operation selected from the group consisting of leaving the first style value unchanged, adding to the first style value an increase_value stored in the one or more tables, subtracting from the first style value a decrease_value stored in the one or more tables, and performing an XOR operation between the first style value and an XOR value stored in the one or more tables.

Some embodiments provide a network packet classification system comprising a parse-lookup stage module configured to derive a style value for a network packet; and a final style module configured to derive a classification value for the packet based on the style value and transmit the classification value to a target, wherein the target is configured to process the packet based on the classification value, wherein the parse-lookup stage module is further configured to receive parse information derived from parsing a field in a network packet; compare the parse information with information in a table to derive a comparison result, wherein the table includes information for mapping the field with one or more comparison results; and based on the comparison result derive the style value for the network packet.

According to some embodiments, the parse-lookup stage module is further configured to derive or receive an initial style value for the network packet, wherein deriving the style value includes modifying the initial style value based on the comparison result. According to some embodiments, the initial style value is derived based on a network path through which the network packet is received. According to some embodiments, the field is a first field, the parse information is a first parse information, the table is one table of one or more tables, the comparison result is a first comparison result, and the style value is a first style value, and wherein the parse-lookup stage module is further configured to: parse a second field in the network packet to derive a second parse information; compare the second parse information with information in the one or more tables to derive a second comparison result; and based on the second comparison result modify the first style value to derive a second style value for the network packet, and wherein the final style module configured to derive the classification value for the packet based on the second style value.

Some embodiments provide a non-transitory computer-readable medium storing a program that, when performed by one or more processors, causes the one or more processors to perform the network packet classification method.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification, and constitute a part of it, illustrate several embodiments consistent with the disclosure. Together with the description, the drawings serve to explain the principles of the disclosure.

In the drawings:

FIG. 1 is a block diagram of a packet parsing system according to some embodiments.

FIG. 2 shows a block diagram that illustrates egress generation mechanisms and methods according to some embodiments.

FIG. 3 shows an illustrative diagram for generating different style values for a packet based on an embodiment.

### DETAILED DESCRIPTION

The following detailed description refers to the accompanying drawings. Wherever possible, the same or similar reference numbers are used in the drawings or in the description to refer to the same or similar parts. Also, similarly-named elements may perform similar functions and may be similarly designed, unless specified otherwise. Numerous details are set forth to provide an understanding of the described embodiments. The embodiments may be practiced without these details. In other instances, well-known methods, procedures, and components have not been described in detail to avoid obscuring the described embodiments.

While several exemplary embodiments and features are described here, modifications, adaptations, and other implementations may be possible, without departing from the spirit and scope of the invention. Accordingly, unless explicitly stated otherwise, the descriptions relate to one or more embodiments and should not be construed to limit the invention as a whole. This is true regardless of whether a reference is or is not explicitly made to state that a feature is relevant to “one or more,” “some,” or “various” embodiments. Instead, the proper scope of the invention is defined by the appended claims. Further, stating that a feature may exist indicates that the feature exists in one or more embodiments.

In this disclosure, the terms “include,” “comprise,” “contain,” and “have,” when used after a set or a system, mean an open inclusion and do not exclude addition of other, non-enumerated, members to the set or to the system. Moreover, as used in this disclosure, a subset of a set can include one or more than one, including all, members of the set.

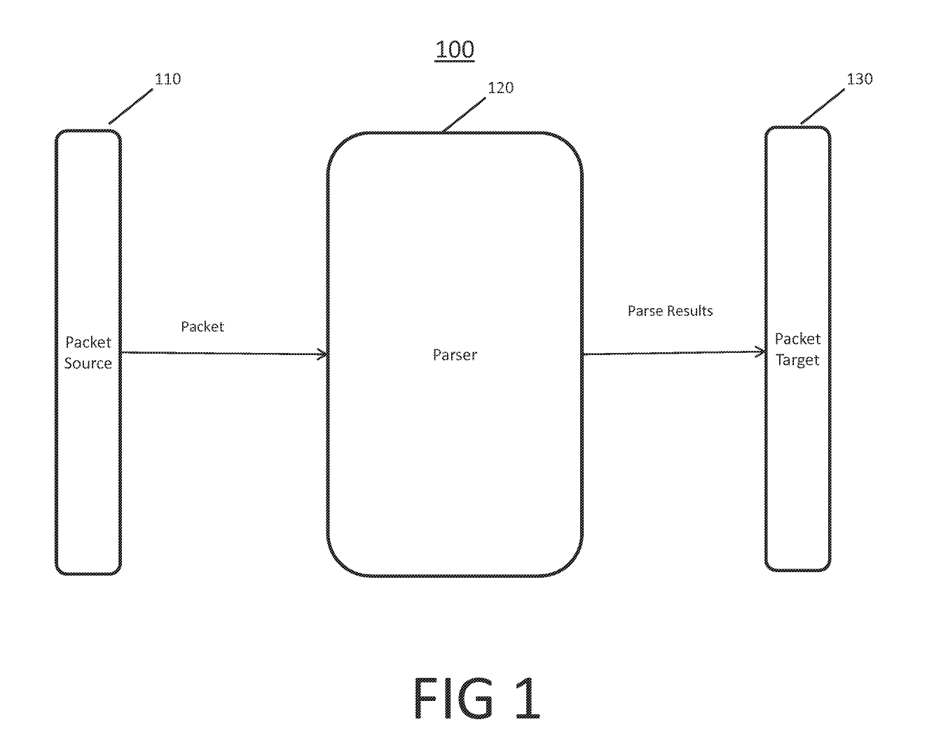

Various embodiments utilize novel patent parsing mechanisms that enable efficient handling of various network packet types. In various embodiments, a packet parsing system receives network packets, parses those packets, and delivers the parse results to one or more recipients (also called here targets). Unless stated otherwise, the terms network packet, packet, or packet data are used interchangeably to indicate network packets that are transmitted according to one or more network protocols. FIG. 1 is a block diagram of a packet parsing system 100 according to some embodiments. Packet parsing system 100 includes a packet source 110, a packet parser 120, and a packet 130.

Packet source 110 sends one or more packets to parser 120. Packet source 110 may include, for example, one or more packet transmitters such as one or more semiconductor systems that implement system 100, an Ethernet MAC, a network switch, a network processor, or a network interface of the one or more computers that implement system 100.

Parser 120 is a parsing system configured to parse the received packets and extracts from those packets some parse results. In some embodiments, the parse results include information related to one or more protocol layers and fields within those protocols according to which the packets are built. In some embodiments, parser 120 includes a plurality of parsing clusters. Each parsing cluster may include one or more parsing engines that are configured to parse received packets.

The parse results, for example, may include the type of the packet's protocol, whether one or more fields or layers of that protocol are present in the packet, the packet destination, or a subset of the information in the layers or fields that are present. In some embodiments, in addition to the above parse results, the parser also derives some other information such as style values or mask tags.

In various embodiments, packet target 130 includes one or more systems that receive from parser 120 the parse results and use those results in their operation. Packet target 130 may also receive a part or the entire parsed packet itself along with the parse results. Packet target 130 may include, for example, parts of one or more computers on which system 100 is installed, an Ethernet MAC, a DMA, a network switch, a network processor, or a network interface.

In various embodiments, packets arriving at a recipient, such as a network processor, a network switch, or a network interface need to be classified into one of a multitude of possible classes. In various embodiments, classes may correspond to the Internet Protocol Differentiated Services (DIFFSRV) classes, Ethernet 802.1 VLAN priority classes, or some other traffic classes.

For classification, some embodiments generate a “wide vector” of all packet data, called an N-tupple (e.g., a 3-tupple, a 5-tupple, or a 7-tupple), which may then be matched against a content addressable memory (CAM). The entry number in the CAM which corresponds to the N-tupple may indicate the class for the packet. Some other embodiments use specific hardware matchers that look for specific fields and values in the packet data, and process the packet according to those fields and values. For example, the hardware may extract a TCP destination port number and may have a register that indicates that a specific TCP destination port should result in exceptional handling for the packet.

Some other embodiments, on the other hand, classify the packets using an egress generation mechanism that generates egress information for the packet. Egress information may classify a packet and facilitate its further processing by the recipient. In various embodiments, the egress information includes one or more of tag values or group numbers. Such egress information may have a smaller size than the wide vector discussed above. In some embodiments, egress information are used in determining the flow of the packets. The flow of the packets may indicate which packets should remain in the same queue or whether they must remain in order, as they are sent to the recipient or further processed by the recipient. In some embodiments, egress information determine how the packet data should be processed. Some egress information, for example, may indicate that one or more sections of the packet data need not be parsed. Some egress information may determine that the packet should be processed by specific set of one or more cores, or transmitted to specific ports.

In some embodiments, the egress generation mechanism generates or updates the egress value for each packet while the packet is being parsed. The egress value may be initialized at the start and then updated in one or more stages of the parsing. Each stage of the parsing may relate to parsing one or more subsections of the packet, such as parsing one layer of multiple layers of the packet as defined by its protocol. To generate or update an egress value, the egress generation mechanism may utilize small sized CAMs. At different parsing stages, as different packet sections are parsed, the mechanism may compare the parse results for that section with one or more related criteria in the CAMs. Based on whether or not a match is found, the mechanism then generates an egress value for the packet or updates the egress value derived up to that stage. Such mechanisms often require much less area than the wide vector mechanism.

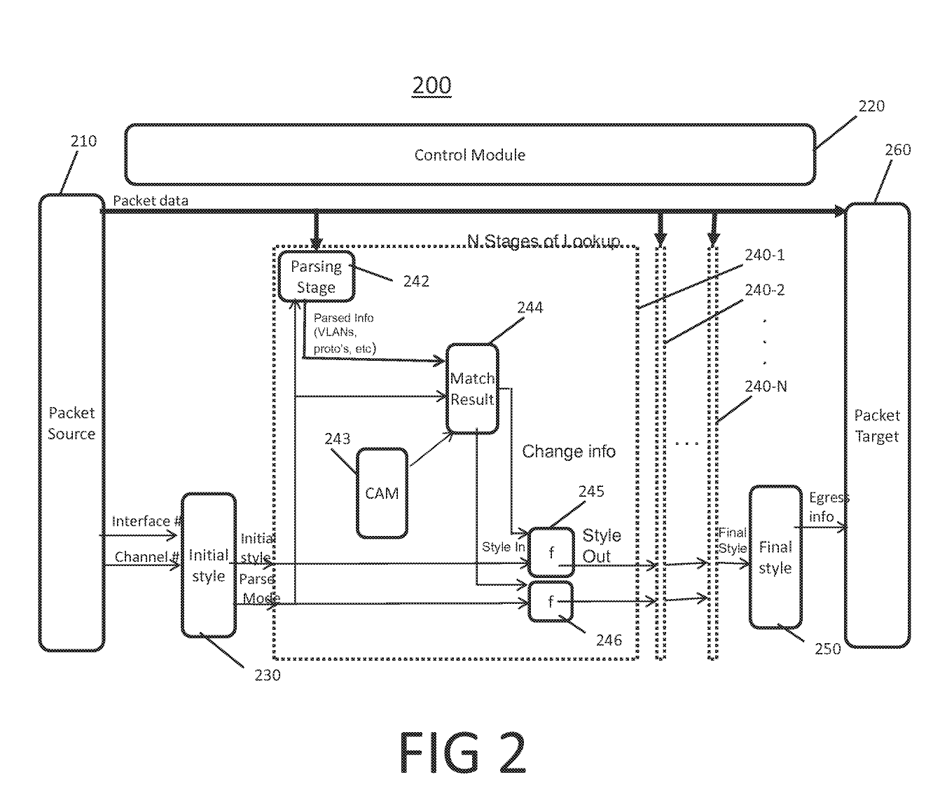

FIG. 2 shows a block diagram 200 that illustrates egress generation mechanisms and methods according to some embodiments. Diagram 200 includes a packet source 210, a control module 220, an initial style module 230, one or more parse-lookup stages 240 (marked in FIGS. 2 as 240-1 to 240-N, where N is an integer greater than or equal to one), an egress generator module 250, and a packet target 260.

Packet source 210 may be configured to transmit the packet to the parser or to the parse-lookup stages 240. Control module 220 is configured to program various tables, such as CAMs, utilized by the egress generator mechanism, as further described below. Initial style module 230 may be configured to provide an initial style value for a packet being parsed. In various embodiment, a style value is one type of an egress value. In some embodiments, a style value is used as an index into a table to determine other egress values.

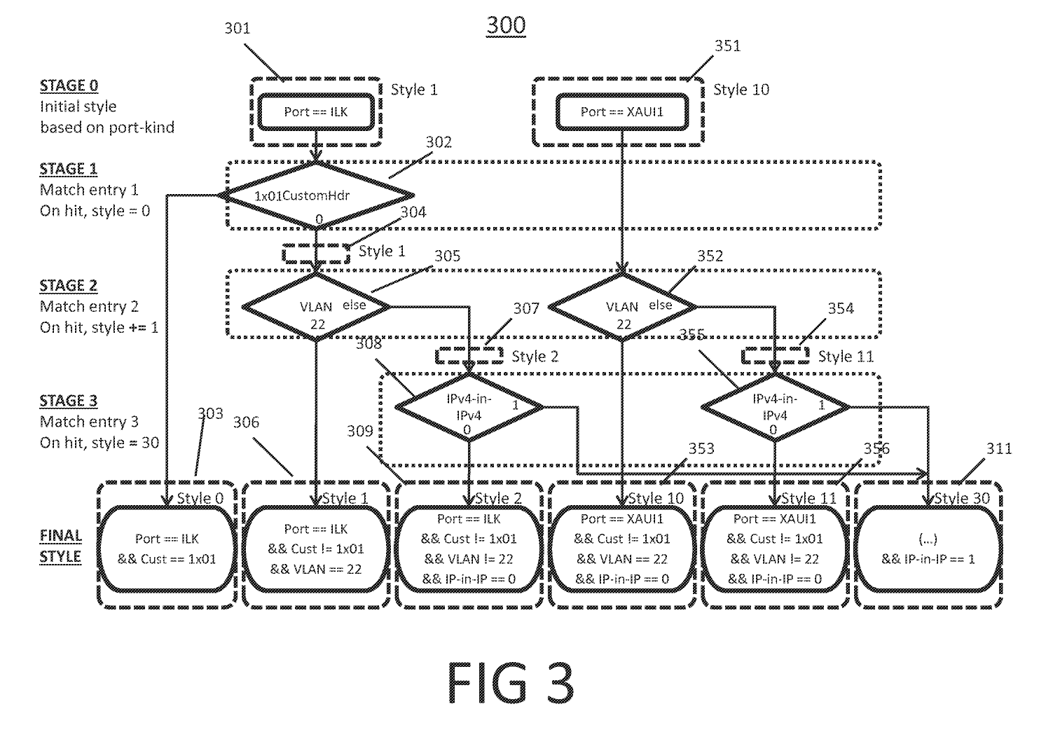

In some embodiments, the packet's style value reflects some aspects of the packet data. For example, as further illustrated in FIG. 3, a style value of 1 may indicate that for the packet the arrival port is ILK, the value of CustomHdr is not 1x01, and the value of VLAN is 22. A style value of 11, on the other hand, may indicate that the arrival port is XAUI1, the value of CustomHdr is not equal to 1x01, the value of VLAN is not 22, and the value of IPv4-in-IPv4 is 0. In various embodiments, a finite number of style values map to different classes used by the system. In one embodiment, the style value is an 8 bits wide number.

Parse-lookup stages 240-1 to 240-N may be configured to generate a style value for a packet using the initial style value and the parse results derived in one or more parsing stages of the packet. Egress generator module 250 is configured to receive one or more style values generated by parse-lookup stages 240. Final style module 250 may receive style values separately from one or more parse-lookup stages 240, or receive a final style value that results from a combination of parse-lookup stages 240. Based on the received data, egress generator module 250 may generate egress information and transmit them to target 260.

Initial style module 230 may initialize the style value. In particular, module 230 may initialize the style value to a fixed number, irrespective of the packet. Alternatively, module 230 may initialize the style value based on some preliminary information about the packet. In some embodiments, module 230 may receive the preliminary information from packet source 210 and accordingly select an initial style. This preliminary information may include, for example, the interface and channel on which the packet arrives. Module 230 may also include a table that maps different preliminary information to different initial style values. Module 230 thus may map the initial information to the initial style value and transmit that initial style value to one or more parse-lookup stages 240-i.

In some embodiments, module 230 may also generate parse mode information and transmit that information to one or more parse-lookup stages 240-i. The parse mode information may also be included in or derived from the style value. The parse mode information may indicate that one or more stages of parsing should be skipped or modified. Based on the parse mode information, the egress generation mechanism may not perform one or more of the stages of parsing and thus skip the corresponding parse-lookup stages. Further, one or more of the parse-lookup stages 240 may modify their parsing process based on the parse mode information. A parse-lookup stage may also modify the parse mode information and transmit that updated parse mode to one or more other parse-lookup stages.

The parse mode information may be, for example, a binary value indicating whether or not the parsing should proceed after a stage. In one example, the value of the parse mode information may indicate what network protocols will be parsed while in this parse mode. Some embodiments do not utilize parse mode information and instead parse the packet independent of the style values generated by the parse-lookup stages.

In some embodiments, a parse-lookup stage 240 includes a parsing stage module 242, a CAM 243, a match result module 244, style generator module 245, and a parse mode generator module 246. In various embodiments, parse-lookup stages 240 are included in a parser. In some embodiments, the parser includes one or more engines, each of which is configured to perform different stages of parsing for a packet. Parsing stage module 242 of each parse-lookup stage 240 may be the corresponding stage as performed by the engine. Alternatively, parsing stage 242 of each parse-lookup stage 240 may be a module that receives from the parser the parse results of a corresponding parsing stage.

In various embodiments, parsing stage 242 parses the packet, possibly taking into account the parse mode information. The parsing stage, for example, may parse as a first item the source Ethernet address in the packet. The parsing stage may determine the location of the source Ethernet address and extract the contents of that field. Parsing stage 242 may transmit the parse results (e.g., the location or content of a field such as the source Ethernet address) to match results module 244. Mach results module 244 may also receive the style value or parse mode information from initial style module 230 or from another parse-lookup stage.

Match results module 244 may compare the parse results with entries in CAM 243. In some embodiments, each CAM entry contains a ternary value that includes possible values of a parsed field, possible starting style numbers, and a corresponding style change value for that field value and starting style number.

In some embodiments, each CAM entry may be specific for a stage. In other embodiments, a single CAM entry may be used in multiple stages; in such a case, an additional field in the CAM, or the style value, may indicate which stage is being processed. Various other embodiments used other combinations of CAM entries, style values, and style change value.

If an entry matches the field data in parse results, the CAM may return the corresponding change information. Match results module 244 may transmit the style change value to one or both of the style generator module 245 and parse mode generator module 246. Style generator module 245 and parse mode generator module 246 may also receive an initial value of the style value or parse mode information from initial style module 230, or a present value of them from match results module 244 or from another parse-lookup stage 240. In some embodiments, at every stage of parsing, the packet's style value reflects some aspects of the parse results up to that point. Two or more of the parse-lookup stages 240 may update the style value in sequence, such that each parse-lookup stage 240 updates and passes the style value to the next parse-lookup stage in the sequence. This updating or passing may also depend on the parse mode, such that some of the parse-lookup stages in the sequence may be skipped or modified based on the parse mode information. In some embodiments, two or more parse-lookup stages perform the parsing in parallel; they may update the style value or parse mode information independent of the other parse-lookup stages.

Based on one or more of the received style change value, parse mode information, and style value, style generator module 245 may generate an updated style value. Equations (1) to (6) below list some illustrative functions that style generator 245 may use to generate an updated style value (here called style_out), based on the received style value (here called style_in) and the received style change value (here called CAM result):

style_out=style_in Eq. (1)

style_out=style_in+CAM result Eq. (2)

style_out=style_in XOR CAM result Eq. (3)

style_out=CAM result. Eq. (4)

style_out=style_in+1 Eq. (5)

style_out=style_in −1 Eq. (6)

According to illustrative Equations (1) to (6), respectively, in different cases style generator module 245 may leave the style value unchanged; add to it the style change value; update the style value by performing an XOR operation with the style change value; update it to the style change value; increment it by one; or decrement it by one.

In some embodiments, parse mode generator module 246 also updates the parse mode information. In some illustrative examples, parse mode generator module 246 may set the parse mode to a specific value in the style change value. Parse mode generator module 246 may also set or clear the parse mode information to enable or disable additional parse features in other parse-lookup stages. After completions of all relevant parse-lookup stages for a packet, one or more generated style values are transmitted to egress generator module 250. Alternatively, the overall result of all relevant parse-lookup stages for a packet may be one final style value that is transmitted to egress generator module 250. Relevant parse-lookup stages for a packet may include those stages that are performed for a packet based on the parse mode information. Based on this input, egress generator module 250 may generate egress information, related to the packet's classification, and transmit them to target 260.

In some embodiments, egress generator module 250 converts the final style into an egress-style value. The egress-style value may be equal to the final style or may be a compressed version of the final style value. The egress generator module 250 may further include a structure that takes in the egress-style value and generates additional egress information, such as group information. In some embodiments, egress generator module 250 generates the additional egress information by looking up into a table for which the indexes are the egress-style values.

Target 260 may use the egress information to determine how to further process the packet. Based on these values, a target switch, for example, may determine the port to which it should forward the packet, or a Network Interface Card (NIC) may determine what buffers it should allocate to the packet.

The egress generation mechanism may thus generate a style value for a packet in one or more stages and based on results of parsing different parts of the packet. FIG. 3 shows an illustrative diagram 300 for generating different style values for a packet based on an embodiment. Diagram 300 includes an initial stage (stage 0) followed by three parse-lookup stages 1-3. Further, diagram 300 includes blocks 301-311 and 351-356, which depict examples of different steps through which the system may derive for a packet one of six final style values listed in blocks 303, 306, 309, 311, 353, and 356.

Stages 0 to 3 illustrate different stages of initializing or updating a style value. In particular, at stage 0, an initial style module generates an initial style value based on the kind of the arrival port for the packet. At stage 1, if CustomHdr (value of a field extracted from the packet) has the value of 1x01, the final style value is set to 0. At stage 2, if the parsed VLAN value is not 22, the style value is incremented by 1. At stage 3, if value of IPv4-IPv4 is 1, the final style value is set to 30.

Blocks 301-311 and 351-356 depict the application of these stages to different packets with different parse results. At block 301, a packet arrives with the arrival port value of ILK. Based on this port value, the system assigns to the packet an initial style value of 1 in block 301. In match block 302, the parse result for CustomHDR is checked against the value of 1x01. If the match is found, the final style of the packet is set to 0, as in bock 303. Alternatively, if the match is not found, the style value remains unchanged (in this case style value 1 of block 304) and the process proceeds to stage 2. At stage 2, in match block 305, the parse result for VLAN is compared with the value 22. If the VLAN value is 22, the style is left unchanged and is output as the final style (in this case, style value 1 of block 306). If, on the other, the VLAN value is not 22, the style is incremented by 1 (in this case to style value 2 of block 307) and the process proceeds to stage 3. At stage 3, in match block 308, the IPv4-in-IPv4 value is checked. If it is 0, the style is unchanged and output as the final style (in this case a final style value of 2 of block 309). If, on the other hand, IPv4-in-IPv4 value is 1, the final style value of 30 is output, as in block 311.

At block 351, on the other hand, a packet arrives with the arrival port value of XAUI1. Based on this port value, the system assigns to the packet an initial style value of 10 in block 351. At stage 2, in match block 352, the parse result for VLAN is compared with the value 22. If the VLAN value is 22, the style is left unchanged and is output as the final style (in this case, style value 10 of block 353). If, on the other hand, the VLAN value is not 22, the style is incremented by 1 (in this case to style value 11 of block 354) and the process proceeds to stage 3. At stage 3, in match block 355, the IPv4-in-IPv4 value is checked. If it is 0, the style is unchanged and output as the final style (in this case a final style value of 11 of block 356). If, on the other hand, IPv4-in-IPv4 value is 1, the final style value of 30 is output, as in block 311.

The above discussed features and structures enable parsers that have a high efficiency as compared to their cost and size. Various embodiments implement mechanisms that result in fixed or deterministic packet parsing times. That is, once the packets are allocated to engines, it can be predicted when each instruction is applied to each packet. Moreover some embodiments enable parsers with parsing rates over 100 Mpackets/second. Various embodiments achieve such speeds while requiring a relatively low size, cost, or power. Moreover, due to their architecture, various embodiments can be updated to adapt to new or evolved packet formats by using new microcode programs and without updating the hardware.

In various embodiments, one or more of modules disclosed in this disclosure are implemented via one or more software programs for performing the functionality of the corresponding modules or via computer processors executing those software programs. In some embodiments, one or more of the disclosed modules are implemented via one or more hardware modules executing firmware for performing the functionality of the corresponding modules. In various embodiments, one or more of the disclosed modules include storage media for storing data used by the module, or software or firmware programs executed by the module. In various embodiments, one or more of the disclosed modules or disclosed storage media are internal or external to the disclosed systems. In some embodiments, the disclosed storage media for storing information include non-transitory computer-readable media, such as computer storage, e.g., a hard disk, or a flash memory, or other types of memory readable by processors or microprocessors. Further, in various embodiments, one or more of the storage media are non-transitory computer-readable media store information or software programs executed by various modules or implementing various methods or flow charts disclosed herein.

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. For example, the steps described need not be performed in the same sequence discussed or with the same degree of separation. Likewise various steps may be omitted, repeated, or combined, as necessary, to achieve the same or similar objectives. Similarly, the systems described need not necessarily include all parts described in the embodiments, and may also include other parts not described in the embodiments. Accordingly, the invention is not limited to the above-described embodiments, but instead is defined by the appended claims in light of their full scope of equivalents.

1. A network packet classification method comprising:
receiving parse information derived from parsing a field in a network packet;
comparing the parse information with information in a table to derive a comparison result, wherein the table includes information for mapping the field with one or more comparison results;
based on the comparison result deriving a style value for the network packet;
classifying the packet based on the style value; and
processing the packet based on the classification.

2. The method of claim 1, further comprising deriving or receiving an initial style value for the network packet, wherein deriving the style value includes modifying the initial style value based on the comparison result.

3. The method of claim 2, wherein the initial style value depends on a network path through which the network packet is received.

4. The method of claim 2, wherein the initial style value includes a parse mode determining how to parse the network packet.

5. The method of claim 4, wherein the network packet includes a plurality of fields and wherein the parse mode determines that one or more of the plurality of fields should be parsed.

6. The method of claim 4, wherein deriving the style value includes modifying the parse mode.

7. The method of claim 3, wherein the network path includes an interface or a channel through which the network packet is received.

8. The method of claim 1, wherein the table is stored in a content addressable memory.

9. The method of claim 1, wherein the field is a first field, the parse information is a first parse information, the table is one table of one or more tables, the comparison result is a first comparison result, and the style value is a first style value, the method further comprising:
receiving second parse information derived from parsing a second field in the network packet;
comparing the second parse information with information in the one or more tables to derive a second comparison result;
based on the second comparison result modifying the first style value to derive a second style value for the network packet; and
classifying the packet based on the second style value.

10. The method of claim 9, wherein modifying the first style value includes, based on the second comparison results, performing an operation selected from the group consisting of leaving the first style value unchanged, adding to the first style value an increase_value stored in the one or more tables, subtracting from the first style value a decrease_value stored in the one or more tables, and performing an XOR operation between the first style value and an XOR value stored in the one or more tables.

11. A network packet classification system comprising:
a parse-lookup stage module configured to derive a style value for a network packet; and
a final style module configured to derive a classification value for the packet based on the style value and transmit the classification value to a target, wherein the target is configured to process the packet based on the classification value,
wherein the parse-lookup stage module is further configured to:
receive parse information derived from parsing a field in a network packet;
compare the parse information with information in a table to derive a comparison result, wherein the table includes information for mapping the field with one or more comparison results; and
based on the comparison result derive the style value for the network packet.

12. The network packet classification system of claim 11, wherein the parse-lookup stage module is further configured to derive or receive an initial style value for the network packet, wherein deriving the style value includes modifying the initial style value based on the comparison result.

13. The network packet classification system of claim 12, wherein the initial style value is derived based on a network path through which the network packet is received.

14. The network packet classification system of claim 11, wherein the field is a first field, the parse information is a first parse information, the table is one table of one or more tables, the comparison result is a first comparison result, and the style value is a first style value, and wherein the parse-lookup stage module is further configured to:
parse a second field in the network packet to derive a second parse information;
compare the second parse information with information in the one or more tables to derive a second comparison result; and
based on the second comparison result modify the first style value to derive a second style value for the network packet,
and wherein the final style module configured to derive the classification value for the packet based on the second style value.

15. A non-transitory computer-readable medium storing a program that, when performed by one or more processors, causes the one or more processors to perform a network packet classification method, the method comprising:
receiving parse information derived from parsing a field in a network packet;
comparing the parse information with information in a table to derive a comparison result, wherein the table includes information for mapping the field with one or more comparison results;
based on the comparison result deriving a style value for the network packet;
classifying the packet based on the style value; and
processing the packet based on the classification.

16. The non-transitory computer-readable medium of claim 15, wherein the method further comprises deriving or receiving an initial style value for the network packet and wherein deriving the style value includes modifying the initial style value based on the comparison result.

17. The non-transitory computer-readable medium of claim 16, wherein the initial style value depends on a network path through which the network packet is received.

18. The non-transitory computer-readable medium of claim 16, wherein the initial style value includes a parse mode determining how to parse the network packet.

19. The non-transitory computer-readable medium of claim 18, wherein the network packet includes a plurality of fields and wherein the parse mode determines that one or more of the plurality of fields should be parsed.

20. The non-transitory computer-readable medium of claim 18, wherein deriving the style value includes modifying the parse mode.
